(19) United States
(12) Patent Application Publication
(10) Pub. No.: US 2026/0111207 A1
(43) Pub. Date: Apr. 23, 2026

(54) FAULT DIAGNOSIS DRIVER LOADING METHOD AND APPARATUS, ELECTRONIC DEVICE, AND STORAGE MEDIUM

(71) Applicant: Suzhou MetaBrain Intellegent Technology Co., Ltd., Suzhou, Jiangsu (CN)

(72) Inventors: Jianliang TANG, Suzhou, Jiangsu (CN); Peng CHEN, Suzhou, Jiangsu (CN); Fei LU, Suzhou, Jiangsu (CN); Xiuqiang SUN, Suzhou, Jiangsu (CN)

(21) Appl. No.: 19/167,697

(22) PCT Filed: Sep. 30, 2024
(86) PCT No.: PCT/CN2024/122665

§ 371 Date: Sep. 22, 2025

(30) Foreign Application Priority Data
Feb. 28, 2024 (CN) 202410224123.7

(51) Int. Cl. G06F 8/61

(52) U.S. Cl. CPC G06F 8/61

(57) ABSTRACT

Embodiments of the present application provide a fault diagnosis driver loading method and apparatus, an electronic device, and a storage medium, and relate to the technical field of fault diagnosis driver loading. By adding a firmware volume file for a basic input and output system to a shared area through a client device, a system control interrupt is executed in a case that a computing device is powered on and the firmware volume file is detected, and the firmware volume file is acquired from the shared area; a power management and configuration interface command is executed to trigger a system management interrupt for the basic input and output system, and a fault diagnosis driver is loaded based on the firmware volume file.

### CROSS-REFERENCE TO RELATED APPLICATION

This application claims priority to Chinese Patent Application No. 202410224123.7, filed on Feb. 28, 2024 in China National Intellectual Property Administration and entitled “FAULT DIAGNOSIS DRIVER LOADING METHOD AND APPARATUS, ELECTRONIC DEVICE, AND STORAGE MEDIUM”, which is hereby incorporated by reference in its entirety.

### FIELD

The present application relates to the technical field of fault diagnosis driver loading, in particular to a fault diagnosis driver loading method and apparatus, an electronic device, and a storage medium.

### BACKGROUND

In today's Internet era, reliability and stability of servers are crucial for normal operations of enterprises and organizations. However, due to hardware faults, software errors, or other unforeseen factors, server faults and downtime issues occur from time to time. These faults and downtime not only lead to data loss and business interruption but may also cause huge economic losses and reputation risks to the enterprises. Therefore, how to quickly locate and repair these faults is relatively important, often requiring rapid updates of fault diagnosis drivers to improve fault diagnosis and localization capabilities.

### SUMMARY

Embodiments of the present application provide a fault diagnosis driver loading method and apparatus, an electronic device, and a computer-readable storage medium. Some embodiments of the present application disclose a fault diagnosis driver loading method applied to a computing device mounted with a basic input and output system, the computing device being configured with a baseboard management controller, the baseboard management controller being configured with a shared area, the shared area being configured to be mapped to a system memory of the basic input and output system, the computing device having a corresponding client device;
the client device being configured to add a firmware volume file for the basic input and output system to the shared area, the method including:
executing a system control interrupt in response to determining that the computing device is powered on and the firmware volume file is detected, and acquiring the firmware volume file from the shared area; and
executing a power management and configuration interface command to trigger a system management interrupt for the basic input and output system, and loading a fault diagnosis driver based on the firmware volume file.

In some embodiments, the client device is configured to:
generate a standard format driver file containing the firmware volume file; and
send the standard format driver file to the baseboard management controller.

In some embodiments, the standard format driver file is configured with a unique check value, and the baseboard management controller is configured to:
execute a cyclic redundancy check on the standard format driver file through the unique check value; and
store the firmware volume file in the shared area in response to passing the cyclic redundancy check on the standard format driver file.

In some embodiments, the computing device is configured with a central processing unit, and the baseboard management controller is configured with a high-level signal pin for the central processing unit. The baseboard management controller is configured to:
generate a high-level signal for the firmware volume file after storing the firmware volume file in the shared area; and
send the high-level signal to the central processing unit based on the high-level signal pin; the high-level signal being configured for enable an operating system of the computing device to detect the firmware volume file.

In some embodiments, the computing device is configured with an advanced configuration and power management interface for the operating system, and a step of executing the system control interrupt includes:
generating a power management and configuration interface command for the advanced configuration and power management interface;
invoking the advanced configuration and power management interface through the power management and configuration interface command to send an interrupt request for the basic input and output system to the basic input and output system;
determining, by the basic input and output system, a system control interrupt vector for a general-purpose event based on a general-purpose event table in response to the interrupt request; and
executing the system control interrupt based on the system control interrupt vector.

In some embodiments, the computing device is configured with a system management mode communication buffer and a timer, and a step of loading the fault diagnosis driver based on the firmware volume file includes:
transferring the firmware volume file to the system management mode communication buffer;
invoking a basic input and output system resident function to read the firmware volume file from the system management mode communication buffer to load a fault diagnosis driver;
in response to determining a start of loading the fault diagnosis driver, determining first target time by using the timer;
in response to determining an end of loading the fault diagnosis driver, determining second target time by using the timer, and generating loading status information for the fault diagnosis driver;
determining update duration information for the fault diagnosis driver based on the first target time and the second target time; and
sending the loading status information and the update duration information to the client device.

In some embodiments, a step of sending the loading status information and the update duration information to the client device includes:
generating an intelligent platform management interface command for the loading status information and the update duration information; and
sending the loading status information and the update duration information to the baseboard management controller based on the intelligent platform management interface command, the baseboard management controller being configured to forward the loading status information and the update duration information to the client device.

In some embodiments, the baseboard management controller is configured to:
generate a record log for the loading status information and the update duration information.

In some embodiments, the client device is configured to:
generate first update result information in response to determining that the loading status information indicates successful loading and determining that an update duration indicated by the update duration information is less than or equal to a preset threshold.

In some embodiments, the client device is configured to:
generate second update result information in response to determining that the loading status information indicates failed loading or determining that the update duration indicated by the update duration information is greater than the preset threshold.

In some embodiments, the client device is configured to:
generate a device identifier for the computing device; and
generate a fault diagnosis driver loading report by using the device identifier, the first update result information, and the second update result information.

In some embodiments, the baseboard management controller is configured to: generate check error information for the standard format driver file in response to failing to pass the cyclic redundancy check on the standard format driver file, and send the check error information to the client device.

In some embodiments, the client device is configured to: send the standard format driver file to the baseboard management controller based on a file transfer protocol.

In some embodiments, the baseboard management controller is configured to: send the check error information to the client device based on a file transfer protocol.

In some embodiments, the baseboard management controller is configured to determine a target static random access memory that is not used; and determine the target static random access memory as the shared area; the method further including:
determining device resource allocation information for the shared area, the device resource allocation information being used for enabling the basic input and output system to determine the shared area; and
acquiring a base address for the shared area and an area offset for the firmware volume file; and
a step of acquiring the firmware volume file from the shared area includes:
acquiring the firmware volume file from the shared area based on the base address and the area offset.

Some embodiments of the present application further disclose a fault diagnosis driver loading method applied to a client device, the client device being configured with a corresponding computing device, the computing device being mounted with a basic input and output system, the computing device being configured with a baseboard management controller, the baseboard management controller being configured with a shared area, the shared area being configured to be mapped to a system memory of the basic input and output system, the method including:
adding a firmware volume file for the basic input and output system to the shared area; the computing device being configured to execute a system control interrupt in response to determining that the computing device is powered on and the firmware volume file is detected, and acquire the firmware volume file from the shared area; and execute a power management and configuration interface command to trigger a system management interrupt for the basic input and output system, and load a fault diagnosis driver based on the firmware volume file.

Some embodiments of the present application further disclose a fault diagnosis driver loading apparatus applied to a computing device mounted with a basic input and output system, the computing device being configured with a baseboard management controller, the baseboard management controller being configured with a shared area, the shared area being configured to be mapped to a system memory of the basic input and output system, the computing device having a corresponding client device;
the client device being configured to add a firmware volume file for the basic input and output system to the shared area, the apparatus including:
a firmware volume file acquisition module configured to execute a system control interrupt in response to determining that the computing device is powered on and the firmware volume file is detected, and acquire the firmware volume file from the shared area; and
a fault diagnosis driver loading module configured to execute a power management and configuration interface command to trigger a system management interrupt for the basic input and output system, and load a fault diagnosis driver based on the firmware volume file.

Some embodiments of the present application further disclose a fault diagnosis driver loading apparatus applied to a client device, the client device being configured with a corresponding computing device, the computing device being mounted with a basic input and output system, the computing device being configured with a baseboard management controller, the baseboard management controller being configured with a shared area, the shared area being configured to be mapped to a system memory of the basic input and output system, the apparatus including:
a firmware volume file addition module configured to add a firmware volume file for the basic input and output system to the shared area; the computing device being configured to execute a system control interrupt in response to determining that the computing device is powered on and the firmware volume file is detected, and acquire the firmware volume file from the shared area; and execute a power management and configuration interface command to trigger a system management interrupt for the basic input and output system, and load a fault diagnosis driver based on the firmware volume file.

Some embodiments of the present application further disclose an electronic device, including one or more processors, a communication interface, a storage device, and a communication bus, where the one or more processors, the communication interface, and the storage device communicate with each other through the communication bus;
the storage device is configured to store a computer-readable instruction, and the computer-readable instruction, when read and executed by the one or more processors, implements the method according to any embodiment of the present application.

Some embodiments of the present application further disclose a non-transitory computer-readable storage medium, where the non-transitory computer-readable storage medium stores a computer-readable instruction, and the computer-readable instruction, when read and executed by the one or more processors, implements the method according to any embodiment of the present application.

### BRIEF DESCRIPTION OF THE DRAWINGS

FIG. 1 is a flowchart of steps of a fault diagnosis driver loading method provided in some embodiments of the present application;

FIG. 2 is a schematic structural diagram of a fault diagnosis driver loading system provided in some embodiments of the present application;

FIG. 3 is a schematic diagram of data interaction for a central processing unit and a baseboard management controller provided in some embodiments of the present application;

FIG. 4 is a flowchart of steps of another fault diagnosis driver loading method provided in some embodiments of the present application;

FIG. 5 is a structural block diagram of a fault diagnosis driver loading apparatus provided in some embodiments of the present application;

FIG. 6 is a structural block diagram of another fault diagnosis driver loading apparatus provided in some embodiments of the present application;

FIG. 7 is a structural block diagram of hardware of an electronic device provided in some embodiments of the present application;

FIG. 8 is a schematic diagram of a computer-readable medium provided in some embodiments of the present application; and

FIG. 9 is a schematic structural diagram of a computing device provided in some embodiments of the present application.

### DETAILED DESCRIPTION

In order to make purposes, features, and advantages of the present application more apparent and understandable, the present application will be further described in detail below in combination with the embodiments with reference to drawings.

In practical applications, out-of-band updating refers to a method of performing updating through interfaces provided by hardware or firmware, either before an operating system starts or while the operating system is running. In contrast, in-band updating is performed by using operating system's own update tools. In-band updating relies on a broadband network. In a case that the network is paralyzed, in-band updating may not be achieved. Meanwhile, related technologies involve storing a firmware volume file in firmware storage device, requiring users to import the firmware volume file to complete the loading of a fault diagnosis driver for a basic input and output system. A restart of the basic input and output system is required to complete updating, resulting in poor business continuity and reduced efficiency in loading the fault diagnosis driver for the basic input and output system.

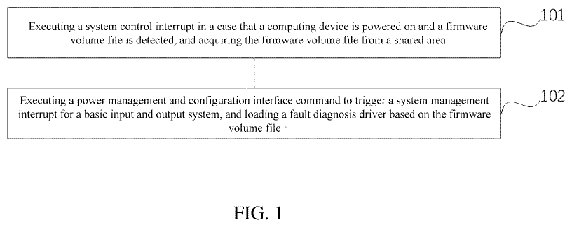

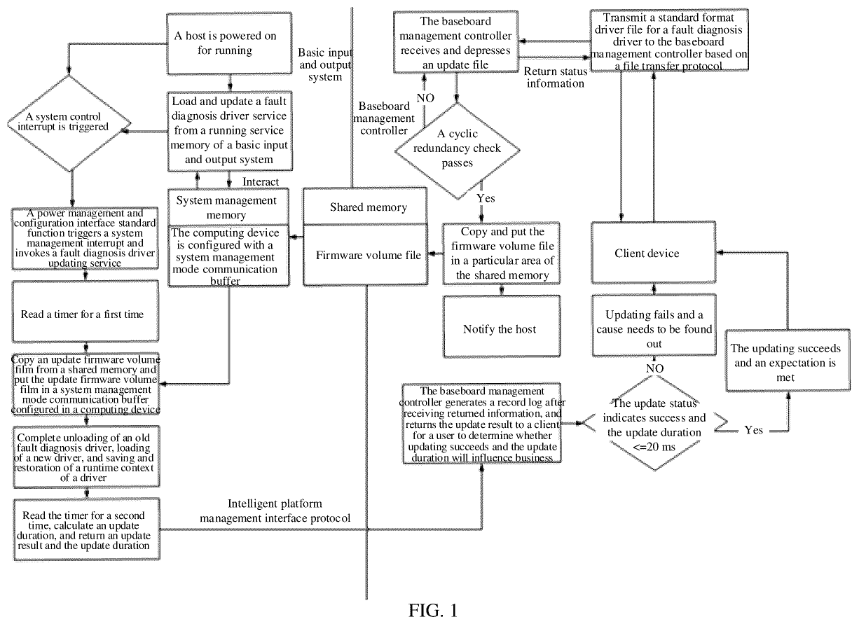

Refer to FIG. 1, which shows a flowchart of steps of a fault diagnosis driver loading method provided in some embodiments of the present application. The method may include following steps:
Step 101: executing a system control interrupt in response to determining that a computing device is powered on and a firmware volume file is detected, and acquiring the firmware volume file from a shared area.
Step 102: executing a power management and configuration interface command to trigger a system management interrupt for a basic input and output system, and loading a fault diagnosis driver based on the firmware volume file.

In practical applications, these embodiments of the present application may be applied to a computing device such as a server, i.e., a host. Refer to FIG. 9. FIG. 9 is a schematic structural diagram of a computing device provided in some embodiments of the present application. The computing device is configured with a Basic Input and Output System (BIOS) and a Baseboard Management Controller (BMC).

The BIOS is a set of programs embedded into a Read-Only Memory (ROM) integrated circuit on a computer's motherboard. It holds the computer's most essential power-on self-test programs, hardware initialization programs, underlying system service programs, and the like.

The BMC is a dedicated service processor that utilizes sensors to monitor status of a computer, a network server, or any other hardware-driven device, and communicates with a system administrator through an independent connection line. The BMC is part of an Intelligent Platform Management Interface (IPMI) and is typically integrated into the motherboard or a main circuit board of the monitored device.

In implementation, these embodiments of the present application may configure a shared area for the baseboard management controller. Exemplarily, an area of a memory not used by the baseboard management controller may be allocated to be configured as the shared area. This shared area may be configured to be mapped into a system memory BIOS Memory of the basic input and output system, thus enabling the basic input and output system BIOS and the baseboard management controller BMC to achieve direct read and write access to the shared area, and avoiding additional data transmission and latency.

In implementation, the computing device has a corresponding client device. In practical applications, the client device may be a device controlled by operation maintenance personnel. In some embodiments, the client device may be connected to multiple computing devices and interact data with the computing devices.

In implementation, these embodiments of the present application may add the firmware volume file (i.e., FV file) used for updating the fault diagnosis driver of the basic input and output system BIOS to the shared area through the client device.

GPE_Lxx SCI (General Purpose Event Low Pin Count System Control Interrupt) is a system control interrupt for handling particular system events. In computer systems, GPE_Lxx SCI is defined by the ACPI (Advanced configuration and power management interface) specification. ACPI is a power management and configuration interface standard for communication between operating systems and computer hardware. The API specification defines a set of system events, such as power button being pressed down, sleep button being pressed down, and high temperature, which may trigger particular processing programs.

For SMI (System Management Interrupt), in order to make it easier for software and hardware designers to design interrupt programs that meet their requirements, the central processing unit CPU mostly provides a system management interrupt SMI. When in use, the CPU needs to enter a System Management Mode (SMM), and the CPU requires a memory area SMRAM (SMRAM System Management RAM). Before entering the SMM, the CPU will store values of registers in the SMRAM, then jump the program to the system management interrupt entry point SMI ENTRY POINT for execution, jump back to an original location through an RSM instruction after processing to continue execution, and simultaneously restore the values of the registers of the CPU.

An Operating System (OS) is a built-in program for collaboration with various hardware components of a computer to interact with users. Commonly used ones include Windows, macOS, and open-source Linux.

Exemplarily, a POST process is a process after the computing device is powered on. In the POST process, a service initialization module in the computing device may initialize a necessary BIOS running service memory (EfiRuntime Services Data) and provide service EfiRuntimeServices for updating the fault diagnosis driver, i.e., a BIOS resident function for initialization.

In response to determining that the computing device Host is powered on, it is determined whether a firmware volume file is detected in the shared area. In response to determining that the firmware volume file is detected in the shared area, a system control interrupt, i.e., GPE_Lxx SCI interrupt, is triggered. The computing device Host may acquire the firmware volume file from the shared area, and then the operating system OS may execute a power management and configuration interface command, i.e., ACPI interface command, to trigger the system management interrupt SMI to invoke the basic input and output system resident function, i.e., the BIOS resident function, to complete the loading and updating of the fault diagnosis driver.

In these embodiments of the present application, by adding the firmware volume file for the basic input and output system to the shared area through the client device, executing the system control interrupt in response to determining that the computing device is powered on and the firmware volume file is detected, and acquiring the firmware volume file from the shared area; executing the power management and configuration interface command to trigger the system management interrupt for the basic input and output system, and loading the fault diagnosis driver based on the firmware volume file, out-of-band fault diagnosis driver loading and updating for the basic input and output system may be achieved, and updating may be completed without restarting the basic input and output system, thus improving the efficiency of loading the fault diagnosis driver for the basic input and output system.

Based on the above embodiment, some variant embodiments of the above embodiments are proposed. It should be noted that, in order to make the description brief, only differences from the above embodiments are described in the variant embodiment.

In some embodiments of the present application, the client device is configured to: generate a standard format driver file containing the firmware volume file; and send the standard format driver file to the baseboard management controller.

In implementation, HPM files are a standardized protocol and file format that ensures consistent format and structure of BIOS update files from different vendors and system integrators.

These embodiments of the present application may use the client device to generate a standard format driver file containing the firmware volume file, i.e., HPM file, and send the standard format driver file to the baseboard management controller, thus simplifying the system management process and enabling more efficient loading and execution of updates for the basic input and output system BIOS.

In some embodiments of the present application, the client device is configured to: send the standard format driver file to the baseboard management controller based on a file transfer protocol.

In practical applications, the File Transfer Protocol (FTP) is a standard protocol suite for transferring files over a network, and operates at a seventh layer of an OSI (Open System Interconnect) model and a fourth layer of a TCP (Transmission Control Protocol) model, i.e., application layer. FTP uses TCP for transmission rather than UDP (User Datagram Protocol). Before establishing a connection, the client and the server undergo a “three-way handshake” process to ensure the connection is reliable and connection-oriented, thus providing guaranteed reliability for data transmission. FTP allows users to communicate with another host by performing file operations (such as creating, deleting, modifying, querying, and transferring files). However, the user does not actually log onto a target computer to become a full user. Instead, an FTP program may be used to access remote resources, enabling functions like bidirectional file transfer, directory management, and email access, even if the two computers involved may have different operating systems and file storage methods.

In implementation, these embodiments of the present application may adopt an out-of-band management tool and employ the file transfer protocol, i.e., FTP, to transmit the standard format driver file HPM to the baseboard management controller BMC, thus ensuring the data security of the standard format driver file HPM during transmission.

In some embodiments of the present application, the standard format driver file is configured with a unique check value. The baseboard management controller is configured to: execute a cyclic redundancy check on the standard format driver file through the unique check value; and store the firmware volume file in the shared area in response to passing the cyclic redundancy check on the standard format driver file.

In practical applications, related technologies often use in-band operating system OS passwords to execute a check on the firmware volume file. This method is not conducive to the batch upgrading and management of the basic input and output system BIOS of multiple computing devices.

In implementation, these embodiments of the present application may generate a unique check value for encrypted check of the firmware volume file when the new firmware volume file is compiled from code and packaged into the standard format driver file HPM. Exemplarily, each byte of the firmware volume file may be included in a calculation using the SHA-256 (Secure Hash Algorithm 256) to generate a unique check value, which is then stored at a header data position of the HPM file, thus allowing the BMC to prioritize reading this unique check value in response to determining to read the data of the HPM file.

Of course, the example above is for exemplary purposes only, and those skilled in the art may employ other algorithms to generate the unique check value, which is not limited in these embodiments of the present application.

A Cyclic Redundancy Check (CRC) code, often abbreviated as cyclic code, is a commonly used error-detecting and error-correcting check code widely employed in early communication systems. The CRC code is frequently applied in data check for external storage devices and synchronous computer communication. Both parity check codes and Hamming codes utilize parity detection as a means for error detection and correction (though parity check codes lack error-correction capability). In contrast, the cyclic redundancy check establishes a predetermined relationship between data bits and check bits through particular mathematical operations.

In implementation, the baseboard management controller BMC in these embodiments of the present application may read the unique check value before decompressing the standard format driver file HPM, execute a cyclic redundancy check CRC on the standard format driver file HPM through the unique check value to ensure the integrity and uniqueness of the firmware volume file, thus guaranteeing data security, decompress the standard format driver file HPM in response to determining that the standard format driver file HPM passes the cyclic redundancy check CRC to obtain the firmware volume file, and store the firmware volume file in the shared area.

In some embodiments of the present application, the baseboard management controller is configured to: generate check error information for the standard format driver file in response to failing to pass the cyclic redundancy check on the standard format driver file, and send the check error information to the client device to inform operation maintenance personnel that controls the client device about that the firmware volume file is not authorized to participate in fault diagnosis driver loading for the basic input and output system.

In some embodiments of the present application, a cyclic redundancy check is executed on the standard format driver file through the unique check value; and the firmware volume file is stored in the shared area in response to passing the cyclic redundancy check on the standard format driver file, thus avoiding the use of an in-band OS password to check the firmware volume file, and improving the efficiency of batch upgrading and management of the basic input and output system BIOS of multiple computing devices.

In order to further improve data security, in some embodiments of the present application, the baseboard management controller may further send the check error information to the client device based on a file transfer protocol.

In some embodiments, the computing device is configured with a central processing unit, and the baseboard management controller is configured with a high-level signal pin for the central processing unit; the baseboard management controller is configured to: generate a high-level signal for the firmware volume file after storing the firmware volume file in the shared area; and send the high-level signal to the central processing unit based on the high-level signal pin. The high-level signal is used for enabling an operating system of the computing device to detect the firmware volume file.

GPIO (General-Purpose Input/Output) functions are similar to ports P0-P3 in the 8051 microcontroller. where pins may be freely configured and controlled by the user through programming. Depending on practical requirements, each pin may be used as General-Purpose Input (GPI), General-Purpose Output (GPO), or General-Purpose Input/Output (GPIO), such as for clk generator or chip select. Since a pin may be used for input, output, or other special functions, there be registers for selecting these functions. For input, the potential of a pin may always be determined by reading a particular register. For output, a pin may be set to output either high or low potential by writing to a designated register. For other special functions, additional dedicated registers are used for controlling.

In implementation, these embodiments of the present application may configure a high-level signal pin for the central processing unit CPU in the baseboard management controller BMC. This high-level signal pin may be implemented as a GPIO pin. The baseboard management controller BMC may connect to the central processing unit CPU through the high-level signal pin. After the baseboard management controller BMC stores the firmware volume file into the shared area, baseboard management controller BMC may generate a high-level signal for the firmware volume file and may send the high-level signal to the central processing unit based on the high-level signal pin, thus enabling the operating system of the computing device to detect the firmware volume file.

In some embodiments of the present application, the computing device is configured with an advanced configuration and power management interface for the operating system, and a step of executing the system control interrupt includes: generating a power management and configuration interface command for the advanced configuration and power management interface; invoking the advanced configuration and power management interface through the power management and configuration interface command to send an interrupt request for the basic input and output system to the basic input and output system; determining, by the basic input and output system, a system control interrupt vector for a general-purpose event based on a general-purpose event table in response to the interrupt request; and executing the system control interrupt based on the system control interrupt vector.

In implementation, these embodiments of the present application may configure an advanced configuration and power management interface for the operating system OS in the computing device Host, generate a power management and configuration interface command for the advanced configuration and power management interface, and invoke the advanced configuration and power management interface through the power management and configuration interface command to send an interrupt request for the basic input and output system to the basic input and output system; after receiving the interrupt request, the basic input and output system may determine a system control interrupt vector for a general-purpose event GPE_Lxx based on a configuration in a general-purpose event table GPE, trigger a GPE_Lxx SCI interrupt through the interrupt vector, and hand cover the control right to the operating system OS. The operating system OS may execute a GPE_Lxx SCI processing program to trigger the SMI to invoke a BIOS resident function and load a fault diagnosis driver based on the firmware volume file.

In these embodiments of the present application, the power management and configuration interface command for the advanced configuration and power management interface is generated through the baseboard management controller; the interrupt request is sent to the basic input and output system through the advanced configuration and power management interface; the basic input and output system determines the system control interrupt vector for the general-purpose event based on the general-purpose event table in response to the interrupt request; the system control interrupt is executed based on the system control interrupt vector, thus achieving the effect of automatically detecting the firmware volume file in the shared area by the operating system to trigger the fault diagnosis driver loading process for the basic input and output system, and improving the efficiency of loading the fault diagnosis driver for the basic input and output system.

In some embodiments of the present application, the computing device is configured with a system management mode communication buffer and a timer, and a step of loading the fault diagnosis driver based on the firmware volume file includes: transferring the firmware volume file to the system management mode communication buffer; invoking a basic input and output system resident function to read the firmware volume file from the system management mode communication buffer to load a fault diagnosis driver; in response to determining a start of loading the fault diagnosis driver, determining first target time by using the timer; in response to determining an end of loading the fault diagnosis driver, determining second target time by using the timer, and generating loading status information for the fault diagnosis driver; determining update duration information for the fault diagnosis driver based on the first target time and the second target time; and sending the loading status information and the update duration information to the client device.

The SMM (System Management Mode) communication buffer is a buffer for communication in a system management mode.

In implementation, these embodiments of the present application may configure an SMM communication buffer and a timer in the computing device; the basic input and output system resident function may firstly read the firmware volume file from the shared area and transfer the firmware volume file to the SMM communication buffer. When invoking the basic input and output system resident function to read the firmware volume file from the SMM communication buffer to start the loading of the fault diagnosis driver, the timer may be read for a first time to determine first target time; then an old fault diagnosis driver is unloaded, a new driver is loaded, and a runtime context of the driver is saved and restored to complete the updating of the fault diagnosis driver. The timer may be read for a second time to determine second target time in response to determining an end of loading the fault diagnosis driver. Exemplarily, an update duration may be calculated in milliseconds (ms). Update duration information for the fault diagnosis driver is determined based on the first target time and the second target time, and the update duration information may be used for indicating a duration spent in loading the fault diagnosis driver. After the loading of the fault diagnosis driver is completed, loading status information for the fault diagnosis driver may be generated, and the loading status information may be used for indicating whether the loading of the fault diagnosis driver for the basic input and output system BIOS is successful.

In these embodiments of the present application, by transferring the firmware volume file to the system management mode communication buffer; invoking the basic input and output system resident function to read the firmware volume file from the system management mode communication buffer to load the fault diagnosis driver; determining the first target time by using the timer in response to determining the start of loading the fault diagnosis driver; determining the second target time by using the timer in response to determining the end of loading the fault diagnosis driver, and generating loading status information for the fault diagnosis driver; determining the update duration information for the fault diagnosis driver based on the first target time and the second target time; and sending the loading status information and the update duration information to the client device, the operation maintenance personnel may subsequently check whether the fault diagnosis driver for the basic input and output system BIOS has been successfully loaded based on the loading status information, and may simultaneously determine whether the loading process has timed out based on the update duration information to determine whether it is necessary to troubleshoot and optimize the update mechanism of the basic input and output system BIOS, thus further improving the efficiency of loading the fault diagnosis driver for the basic input and output system BIOS.

In some embodiments of the present application, a step of sending the loading status information and the update duration information to the client device includes: generating an intelligent platform management interface command for the loading status information and the update duration information; and sending the loading status information and the update duration information to the baseboard management controller based on the intelligent platform management interface command. The baseboard management controller is configured to forward the loading status information and the update duration information to the client device.

In practical applications, the IPMI (Intelligent Platform Management Interface) may span different operating systems, firmware, and hardware platforms, intelligently monitor, control, and automatically report the operational status of a large number of servers to reduce the server system cost.

In implementation, these embodiments of the present application may generate an intelligent platform management interface command for the loading status information and the update duration information, and send the loading status information and the update duration information to the baseboard management controller BMC based on the intelligent platform management interface command, and the baseboard management controller BMC may forward the loading status information and the update duration information to the client device, to improve the data transmission efficiency for the loading status information and the update duration information.

In some embodiments of the present application, the baseboard management controller BMC may be configured to generate a record log for the loading status information and the update duration information, to ensure that in a case of failure in data transmission for the loading status information and the update duration information, a loading result for the fault diagnosis driver may be determined by reviewing the record log.

In some embodiments of the present application, the client device may generate first update result information in response to determining that the loading status information indicates successful loading and an update duration indicated by the update duration information is less than or equal to a preset threshold, to inform the operation maintenance personnel about that the update of the fault diagnosis driver succeeds and the update duration meets an expectation; and generate second update result information in response to determining that the loading status information indicates failed loading or determining that the update duration indicated by the update duration information is greater than the preset threshold, so inform the operation maintenance personnel about that the update of the fault diagnosis driver fails or the update duration does not meet the expectation.

In some embodiments of the present application, the client device may be configured to generate a device identifier for the computing device; and generate a fault diagnosis driver loading report by using the device identifier, the first update result information, and the second update result information.

Exemplarily, the fault diagnosis driver loading report may be presented in a form of a table, server IP (Internet Protocol) addresses serving as device identifiers and to be updated are put in a first column of the table. The client device may traverse the table during updating and simultaneously complete the loading of the fault diagnosis driver for the computing devices, the loading status information and the update duration information are respectively saved in a second column and a third column, data rows where the computing devices corresponding to the first update result information are located are marked with a first color, data rows where the computing devices corresponding to the second update result information are located are marked with a second color, and the table is outputted and sent to relevant parties, thus achieving smarter and more efficient operation maintenance.

In some embodiments of the present application, the baseboard management controller is configured to determine a target static random access memory that is not used; and determine the target static random access memory as the shared area; the method further includes: determining device resource allocation information for the shared area, where the device resource allocation information is used for enabling the basic input and output system to determine the shared area; and acquiring a base address for the shared area and an area offset for the firmware volume file; the step of acquiring the firmware volume file from the shared area includes: acquiring the firmware volume file from the shared area based on the base address and the area offset.

In implementation, these embodiments of the present application may adopt the baseboard management controller BMC to determine a target static random access memory SRAM that is not used, determine the target static random access memory SRAM as the shared area, and simultaneously map the target static random access memory SRAM into the system memory BIOS Memory, enabling both the BIOS and the BMC to achieve read and write access to the shared area. These embodiments of the present application may determine device resource allocation information for the shared area. Exemplarily, the device resource allocation information may include BUS: bus number, Device: device number, and Function: function number. The BIOS may locate a corresponding shared memory through the particular bus number, device number, and function number, acquire a base address of the shared area and an area offset where the FV file (firmware volume file) is stored, and complete a data copy operation for the firmware volume file based on the base address and the area offset.

In practical applications, Copy Handler is a program for copying/moving files and folders between different storage media (such as hard drives, floppy disks, LANs, CDs, and others).

In some embodiments of the present application, CRC 32-bit calculation may also be performed through Copy Hander according to the acquired HPM file to compare with a unique check value at a header data position to ensure consistency and data integrity.

In order to enable those skilled in the art to better understand the embodiments of the present application, the embodiments of the present application will be described below by adopting a complete example.

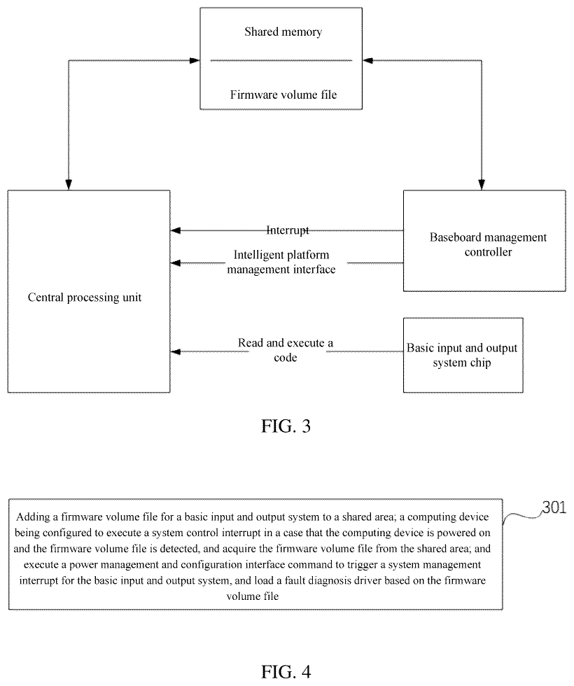

Refer to FIG. 2 and FIG. 3. FIG. 2 is a schematic structural diagram of a fault diagnosis driver loading system provided in some embodiments of the present application. FIG. 3 is a schematic diagram of data interaction for a central processing unit and a baseboard management controller provided in some embodiments of the present application. The baseboard management controller is connected to the central processing unit through an intelligent platform management interface. A shared area (SRAM) opened up by the baseboard management controller BMC is mapped into a system memory BIOS Memory. Both the basic input and output system BIOS and the baseboard management controller BMC may achieve read and write access. A fault diagnosis driver is transmitted to the baseboard management controller BMC, and then the baseboard management controller BMC places the fault diagnosis driver in the shared memory and notifies the Host. The Host triggers a GPE_Lxx SCI interrupt after receiving a change. The operating system OS executes an ACPI interface command to trigger the SMI to invoke a BIOS resident function to complete the updating of the fault diagnosis driver. The resident function firstly reads the FV file from the shared memory and places the FV file in the SMM (System Management Mode) communication buffer. Then, unloading of an old fault diagnosis driver, erasion of a corresponding area, loading of a new driver, and saving and restoration of a runtime context of the driver are performed. An update status is notified to the BMC via an IPMI command. The BMC, after receiving the command, returns an update result to the client. Further, since it is out-of-band updating, server IP addresses to be updated may be put in a first column of a table. During updating, the Excel table is traversed to simultaneously complete the updating of the fault diagnosis driver for the server. Return results (whether the updating is successful, update duration) are respectively saved in a second column and a third column. Corresponding data rows are marked red in response to determining that the updating fails. Corresponding data rows are marked yellow in response to determining that the update duration exceeds a preset update duration. An update result table is outputted and sent to relevant parties via email.

Compared with the traditional fault diagnosis driver updating method, this solution does not require an in-band OS password and adopts a standard HPM format for out-of-band upgrading, thus facilitating batch upgrading and management. During system operation, the fault diagnosis driver is updated out of band by the baseboard management controller BMC, which takes effect in real time and avoids issues such as manually importing fault diagnosis strategies through firmware updates and restarts in conventional solutions, thus improving the efficiency, saving the manpower and the time, avoiding affecting the business continuity of the user, and providing great convenience for research and development testing. Completing the updating through the above method brings many advantages. Firstly, by mapping the shared area (SRAM) into the BIOS Memory, the BIOS and the BMC may directly achieve read and write access, thus avoiding additional data transmission and latency. Secondly, by transmitting the fault diagnosis driver to the BMC and notifying the Host through the shared memory, real-time fault diagnosis and driver updating may be achieved. This is very important for timely detection and resolution of system faults, thus improving the reliability and stability of the system. In addition, by using the SMM communication buffer and SMI mechanism, seamless loading of the driver and saving and restoration of the runtime context may be achieved, thus ensuring the normal operation of the driver and the stability of the system. That is, by updating the fault diagnosis driver out of band through the BMC, the security is improved, the manageability is improved, the continuous availability time of the entire machine is increased, and the delay time is reduced in magnitude, a stable and secure business operating environment is provided for business sensitive customers, the user experience is improved, and the use efficiency and practicality of the server are improved.

Refer to FIG. 4, which shows a flowchart of steps of another fault diagnosis driver loading method provided in some embodiments of the present application. The method may include the following step:
Step 301: adding a firmware volume file for a basic input and output system to a shared area; a computing device being configured to execute a system control interrupt in response to determining that the computing device is powered on and the firmware volume file is detected, and acquire the firmware volume file from the shared area; and execute a power management and configuration interface command to trigger a system management interrupt for the basic input and output system, and load a fault diagnosis driver based on the firmware volume file.

In implementation, these embodiments of the present application may be applied to a client device, the client device is configured with a corresponding computing device, the computing device is mounted with a basic input and output system, the computing device is configured with a baseboard management controller, the baseboard management controller is configured with a shared area, and the shared area is configured to be mapped to a system memory of the basic input and output system.

For the client device side embodiment, due to basic similarity with the computing device side method embodiment, the description is relatively simple. For relevant information, refer to the description of the computing device side method embodiment.

It needs to be stated that in the method embodiments, for the convenience of description, steps are expressed as a series of action combinations. However, those skilled in the art should understood that the embodiments of the present application are not limited by the order of the described actions, as according to the embodiments of the present application, some steps may be performed in other orders or simultaneously. In addition, those skilled in the art should also know that actions involved in the embodiments described in the description are not necessarily mandatory to the embodiments of the present application.

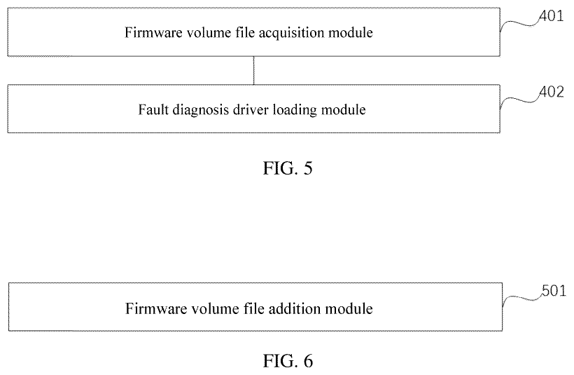

Refer to FIG. 5, which shows a structural block diagram of a fault diagnosis driver loading apparatus provided in some embodiments of the present application. The apparatus may include:
a firmware volume file acquisition module 401 configured to execute a system control interrupt in response to determining that a computing device is powered on and a firmware volume file is detected, and acquire the firmware volume file from a shared area; and a fault diagnosis driver loading module 402 configured to execute a power management and configuration interface command to trigger a system management interrupt for a basic input and output system, and load a fault diagnosis driver based on the firmware volume file.

Refer to FIG. 6, which shows a structural block diagram of another fault diagnosis driver loading apparatus provided in some embodiments of the present application. The apparatus may include:
a firmware volume file addition module 501 configured to add a firmware volume file for a basic input and output system to a shared area; a computing device being configured to execute a system control interrupt in response to determining that the computing device is powered on and the firmware volume file is detected, and acquire the firmware volume file from the shared area; and execute a power management and configuration interface command to trigger a system management interrupt for the basic input and output system, and load a fault diagnosis driver based on the firmware volume file.

For the apparatus embodiments, due to basic similarity with the method embodiments, the description is relatively simple. For relevant information, refer to the description of the method embodiments.

In addition, some embodiments of the present application further provides an electronic device, including: one or more processors, a storage device, and a computer-readable instruction stored in the storage device and runnable on the processor, where the computer-readable instruction, when executed by the one or more processor, implements each process in the fault diagnosis driver loading method embodiments, and may achieve the same technical effect, which will not be repeated here in order to avoid repetition.

Some embodiments of the present application further provides a non-transitory computer-readable storage medium, where the non-transitory computer-readable storage medium stores a computer-readable instruction, and the computer-readable instruction, when executed by one or more processors, implements each process in the fault diagnosis driver loading method embodiments, and may achieve the same technical effect, which will not be repeated here in order to avoid repetition. The non-transitory computer-readable storage medium may be an ROM, a Random Access Memory (RAM), a magnetic disk, or an optical disk.

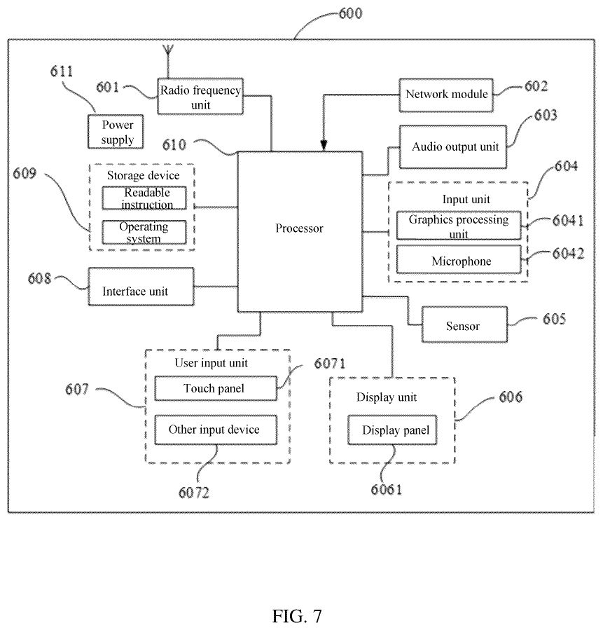

FIG. 7 is a schematic structural diagram of hardware of an electronic device for implementing each embodiment of the present application.

The electronic device 600 includes, but not limited to, a radio frequency unit 601, a network module 602, an audio output unit 603, an input unit 604, a sensor 605, a display unit 606, a user input unit 607, an interface unit 608, a storage device 609, a processor 610, and a power supply 611. Those skilled in the art may understand that the structure of the electronic device shown in FIG. 7 does not constitute any limitation on the electronic device, which may include more or fewer components than those shown therein or a combination of some components, or a different component deployment may be adopted. In the embodiments of the present application, the electronic device includes, but not limited to, a mobile phone, a tablet, a laptop, a palm-held computer, a car-mounted terminal, a wearable device, a pedometer, and the like.

It should be understood that in the embodiments of the present application, the radio frequency unit 601 may be configured to receive and transmit a signal in a process of transmitting and receiving information or communication. In some embodiments, after receiving downlink data from a base station, it is processed by the processor 610; additionally, uplink data are transmitted to the base station. Generally, the radio frequency unit 601 includes, but not limited to, an antenna, at least one amplifier, a transceiver, a coupler, a low noise amplifier, a duplexer, or the like. In addition, the radio frequency unit 601 may communicate with a network and other devices through a wireless communication system.

The electronic device provides the user with wireless broadband Internet access through the network module 602. For example, it helps the user to send and receive emails, browse web pages, and access streaming media.

The audio output unit 603 may convert audio data received by the radio frequency unit 601 or the network module 602 or stored in the storage device 609 into audio signals and output them as sound. In addition, the audio output unit 603 may also provide audio outputs (such as call signal reception sound, message reception sound, and the like) related to particular functions performed by the electronic device 600. The audio output unit 603 includes a speaker, a buzzer, a receiver, or the like.

The input unit 604 is configured to receive an audio or video signal. The input unit 604 may include a Graphics Processing Unit (GPU) 6041 and a microphone 6042. The graphics processing unit 6041 performs processing on image data of a static picture or a video that is obtained by an image acquisition device (for example, a camera) in a video acquisition mode or an image acquisition mode. Processed image frames may be displayed on the display unit 606. Image frames processed by the graphics processing unit 6041 may be stored in the storage device 609 (or other storage media) or sent via the radio frequency unit 601 or network module 602. The microphone 6042 may receive sound and process the sound into audio data. Processed audio data may be converted into a format output that may be sent to a mobile communication base station via the radio frequency unit 601 in a telephone call mode.

The electronic device 600 further includes at least one sensor 605, such as a light sensor, a motion sensor, and other sensors. In some embodiments, the light sensor includes an ambient light sensor and a proximity sensor, where the ambient light sensor may adjust the brightness of a display panel 6061 according to the brightness of the ambient light, and the proximity sensor may turn off the display panel 6061 and/or backlight when the electronic device 600 is moved to the ear. As a type of motion sensor, an accelerometer sensor may detect the magnitude of acceleration in various directions (usually three-axis), may detect the magnitude and direction of gravity when stationary, and may be configured to recognize electronic device posture (such as portrait and landscape screen switching, related games, magnetometer posture calibration), vibration recognition related functions (such as pedometers, strikes), and the like. The sensor 605 may further include a fingerprint sensor, a pressure sensor, an iris sensor, a molecular sensor, a gyroscope, a barometer, a hygrometer, a thermometer, an infrared sensor, or the like, which will not be repeated here.

The display unit 606 is configured to display information inputted by the user or information provided to the user. The display unit 606 may include a display panel 6061. The display panel 6061 may be configured in the form of a Liquid Crystal Display (LCD), Organic Light-Emitting Diode (OLED), or the like.

The user input unit 607 may be configured to receive inputted digit or character information, and generate a keyboard signal input related to user settings and function control of the electronic device. In some embodiments, the user input unit 607 includes a touch panel 6071 and another input device 6072. The touch panel 6071, also known as a touch screen, may collect user touch operations on or near it (such as user operations performed by using a finger, stylus, or any suitable object or accessory on the touch panel 6071 or near the touch panel 6071). The touch panel 6071 may include two parts, namely a touch detection apparatus and a touch controller. The touch detection apparatus is configured to detect a user's touch direction, detect a signal brought by the touch operation, and transmit the signal to the touch controller. The touch controller is configured to receive touch information from the touch detection apparatus, convert it into touch point coordinates, transmit them to the processor 610, and receive and execute a command from the processor 610. In addition, the touch panel 6071 may be implemented by adopting various types such as resistive, capacitive, infrared, and surface acoustic wave types. In addition to the touch panel 6071, the user input unit 607 may further include the other input device 6072. In some embodiments, the other input device 6072 may include, but not limited to, a physical keyboard, a functional key (such as a volume control key or an on/off key), a track ball, a mouse, and a joystick, which will not be repeated here.

Further, the touch panel 6071 may cover the display panel 6061. When detecting a touch operation on or near it, the touch panel 6071 sends it to the processor 610 to determine the type of touch event. Subsequently, the processor 610 provides corresponding visual output on the display panel 6061 according to the type of touch event. Although in FIG. 7, the touch panel 6071 and the display panel 6061 are used as two independent components to achieve the input and output functions of the electronic device, in some embodiments, the touch panel 6071 and the display panel 6061 may be integrated to achieve the input and output functions of the electronic device, which is not limited here.

The interface unit 608 is an interface for connecting an external apparatus to the electronic device 600. For example, the external apparatus may include a wired or wireless headphone port, an external power supply (or battery charger) port, a wired or wireless data port, a memory card port, a port for connecting an apparatus having an identification module, an audio input/output (I/O) port, a video I/O port, a headphone port, or the like. The interface unit 608 may be configured to receive an input (such as data information or power) from the external apparatus and transmit the received input to one or more components in the electronic device 600, or may be configured to transmit data between the electronic device 600 and the external apparatus.

The storage device 609 may be configured to store a software program and various data. The storage device 609 may mainly include a program storage area and a data storage area. The program storage area may store an operating system, an application program required by at least one function (such as a sound play function or an image play function), and the like. The data storage area may store data (such as audio data or phone book) created based on the use of a mobile phone. In addition, the storage device 609 may include a high-speed random access memory, and may also include a non-volatile memory such as at least one disk storage device, flash device, or other non-volatile solid-state storage device.

The processor 610 is a control center of the electronic device, which connects various parts of the entire electronic device through various interfaces and lines. By running or executing the software program and/or modules stored in the storage device 609, as well as invoking data stored in the storage device 609, various functions of the electronic device are executed and data are processed, thus monitoring the electronic device as a whole. The processor 610 may include one or more processing units. In some embodiments, the processor 610 may integrate an application processor and a modulation and demodulation processor. The application processor mainly processes the operating system, user interfaces and application programs. The modulation and demodulation processor mainly process wireless communication. It may be understood that the modulation and demodulation processor may not be integrated into the processor 610.

The electronic device 600 may further include a power supply 611 (such as a battery) for supplying power to each component. In some embodiments, the power supply 611 may be logically connected to the processor 610 through a power supply management system, thus implementing functions such as charging, discharging, and power consumption management through the power supply management system.

In addition, the electronic device 600 includes some functional modules that are not shown, which will not be repeated here.

The terms “include”, “comprise” or any other variation thereof are intended to cover non-exclusive inclusion, so that a process, method, item or device that includes a series of elements not only includes those elements, but also other elements that are not explicitly listed, or also include elements inherent in such a process, method, item or device. Without further limitations, the element limited by the statement ‘including a . . . ’ does not exclude the existence of another identical element in a process, method, item or device that includes that element.

Through the description of the above embodiments, those skilled in the art may clearly understand that the above embodiments may be implemented through software and necessary universal hardware platforms. Of course, they may also be implemented through hardware. However, in many cases, the former is better. Based on this understanding, the technical solution of the present application, or the part that contributes to the related technology, may be reflected in the form of a software product, which is stored in a storage medium (such as ROM/RAM, magnetic disk or optical disk), including several instructions to enable a terminal (which may be a mobile phone, a computer, a server, an air conditioner or a network device) to execute the method described in each embodiment of the present application.

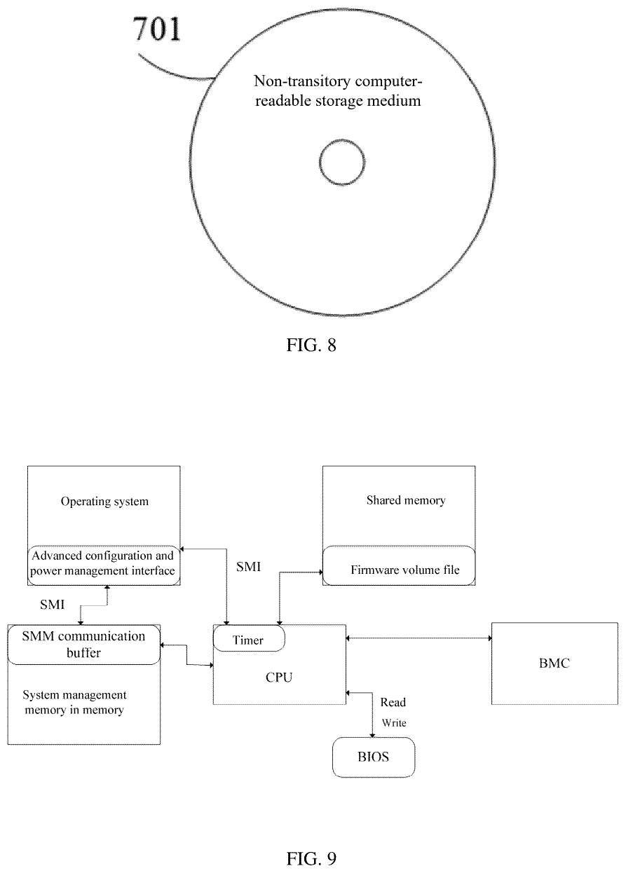

As shown in FIG. 8, in some embodiments provided in the present application, a computer-readable storage medium 701 is further provided. An instruction is stored in the computer-readable storage medium, which, when run on a computer, causes a computer to execute the fault diagnosis driver loading method in the embodiments described above.

The embodiments of the present application have been described above with reference to the drawings. However, the present application is not limited to the embodiments above. The embodiments above are only exemplary rather than restrictive. Under the inspiration of the present application, those skilled in the art may make many variations without departing from the essence and the scope of protection of the present application, which, however, still fall within the scope of protection of the present application.

Those skilled in the art may understand that, units and algorithm steps of the examples described in the disclosed embodiments of the present application may be implemented by electronic hardware, computer software, or a combination thereof. Whether these functions are executed in the form of hardware or software depends on particular applications and design constraint conditions of the technical solutions. Those skilled in the art may use different methods to implement the described functions for each particular application, but it should not be considered that the implementation goes beyond the scope of the present application.

Those skilled in the art may clearly understand that for convenience and conciseness of description, for the working processes of the systems, devices and units described above, a reference may be made to the corresponding processes in the method embodiments, which will not be repeated here.

In the embodiments provided in the present application, it should be understood that the disclosed apparatus and method may be implemented in other manners. For example, the described apparatus embodiments are merely examples. For example, the unit division is merely a logical function division and may be other division during actual implementation. For example, multiple units or components may be combined or integrated into another system, or some features may be ignored or not performed. Moreover, the mutual coupling or direct coupling or communication connection displayed or discussed may be indirect coupling or communication connection through some interfaces, devices or units, which may be electrical, mechanical or other forms.

The units described as separate components may or may not be physically separated, and the components displayed as units may or may not be physical units, and may be located in one place or may be distributed over multiple network units. Some or all of the units may be selected according to actual needs to achieve the purposes of the solutions of the embodiments.

In addition, the functional units in various embodiments of the present application may be integrated into one processing unit or may exist separately and physically, or two or more units may be integrated into one unit.

In a case that the function is implemented in the form of a software functional unit and sold or used as an independent product, it may be stored in a computer-readable storage medium. Based on such an understanding, the technical solutions of the present application essentially, or the part contributing to the related technology, or some of the technical solutions may be implemented in the form of a software product. The computer software product is stored in a storage medium and includes several instructions for instructing a computer device (which may be a personal computer, a server, a network device, or the like) to execute all or some of the steps of the methods described in the embodiments of the present application. The foregoing storage medium includes various media that may store program codes, such as USB flash disks, mobile hard disks, ROMs, RAMs, magnetic disks, or optical disks.

What are described above are merely embodiments of the present application, but are not intended to limit the scope of protection of the present application. Any variation or replacement readily figured out by those skilled in the art within the technical scope disclosed in the present application shall fall within the scope of protection of the present application. Therefore, the scope of protection of the present application shall be subject to the scope of protection of the claims.

1. A fault diagnosis driver loading method, being applied to a computing device mounted with a basic input and output system, the computing device being configured with a baseboard management controller, the baseboard management controller being configured with a shared area, the shared area being configured to be mapped to a system memory of the basic input and output system, the computing device having a corresponding client device;
the client device being configured to add a firmware volume file for the basic input and output system to the shared area, the method comprising:
executing a system control interrupt when the computing device is powered on and the firmware volume file is detected, and acquiring the firmware volume file from the shared area; and
executing a power management and configuration interface command to trigger a system management interrupt for the basic input and output system, and loading a fault diagnosis driver based on the firmware volume file.

2. The method according to claim 1, wherein the client device is configured to:
generate a standard format driver file containing the firmware volume file; and
send the standard format driver file to the baseboard management controller.

3. The method according to claim 2, wherein the standard format driver file is configured with a unique check value, and the baseboard management controller is configured to:
execute a cyclic redundancy check on the standard format driver file through the unique check value; and
store the firmware volume file in the shared area in response to passing the cyclic redundancy check on the standard format driver file.

4. The method according to claim 3, wherein the computing device is configured with a central processing unit, and the baseboard management controller is configured with a high-level signal pin for the central processing unit; the baseboard management controller being configured to:
generate a high-level signal for the firmware volume file after storing the firmware volume file in the shared area; and
send the high-level signal to the central processing unit based on the high-level signal pin; the high-level signal being configured to enable an operating system of the computing device to detect the firmware volume file.

5. The method according to claim 4, wherein the computing device is configured with an advanced configuration and power management interface for the operating system, and executing the system control interrupt comprises:
generating the power management and configuration interface command for the advanced configuration and power management interface;
invoking the advanced configuration and power management interface through the power management and configuration interface command to send an interrupt request for the basic input and output system to the basic input and output system;
determining, by the basic input and output system, a system control interrupt vector for a general-purpose event based on a general-purpose event table in response to the interrupt request; and
executing the system control interrupt based on the system control interrupt vector.

6. The method according to claim 5, wherein the computing device is configured with a system management mode communication buffer and a timer, and loading the fault diagnosis driver based on the firmware volume file comprises:
transferring the firmware volume file to the system management mode communication buffer;
invoking a basic input and output system resident function to read the firmware volume file from the system management mode communication buffer to load the fault diagnosis driver;
in response to determining a start of loading the fault diagnosis driver, determining a first target time by using the timer;
in response to determining an end of loading the fault diagnosis driver, determining a second target time by using the timer, and generating loading status information for the fault diagnosis driver;
determining update duration information for the fault diagnosis driver based on the first target time and the second target time; and
sending the loading status information and the update duration information to the client device.

7. The method according to claim 6, wherein sending the loading status information and the update duration information to the client device comprises:
generating an intelligent platform management interface command for the loading status information and the update duration information; and
sending the loading status information and the update duration information to the baseboard management controller based on the intelligent platform management interface command, the baseboard management controller being configured to forward the loading status information and the update duration information to the client device.

8. The method according to claim 7, wherein the baseboard management controller is configured to:
generate a record log for the loading status information and the update duration information.

9. The method according to claim 7, wherein the client device is configured to:
generate first update result information in response to determining that the loading status information indicates successful loading and determining that an update duration indicated by the update duration information is less than or equal to a preset threshold.

10. The method according to claim 9, wherein the client device is configured to:
generate second update result information in response to determining that the loading status information indicates failed loading or the update duration indicated by the update duration information is greater than the preset threshold.

11. The method according to claim 10, wherein the client device is configured to:
generate a device identifier for the computing device; and
generate a fault diagnosis driver loading report by using the device identifier, the first update result information, and the second update result information.

12. The method according to claim 3, wherein the baseboard management controller is configured to:
generate check error information for the standard format driver file in response to failing to pass the cyclic redundancy check on the standard format driver file, and send the check error information to the client device.

13. The method according to claim 2, wherein the client device is configured to:
send the standard format driver file to the baseboard management controller based on a file transfer protocol.

14. The method according to claim 12, wherein the baseboard management controller is configured to:
send the check error information to the client device based on a file transfer protocol.

15. The method according to claim 11, wherein the baseboard management controller is configured to determine a target static random access memory that is not used; and determine the target static random access memory as the shared area; the method further comprising:
determining device resource allocation information for the shared area, the device resource allocation information being used for enabling the basic input and output system to determine the shared area; and
acquiring a base address for the shared area and an area offset for the firmware volume file; and
a step of acquiring the firmware volume file from the shared area comprises:
acquiring the firmware volume file from the shared area based on the base address and the area offset.

16. A fault diagnosis driver loading method, being applied to a client device, the client device being configured with a corresponding computing device, the computing device being mounted with a basic input and output system, the computing device being configured with a baseboard management controller, the baseboard management controller being configured with a shared area, the shared area being configured to be mapped to a system memory of the basic input and output system, the method comprising:
adding a firmware volume file for the basic input and output system to the shared area;
the computing device being configured to:
execute a system control interrupt in response to determining that the computing device is powered on and the firmware volume file is detected, and acquire the firmware volume file from the shared area; and
execute a power management and configuration interface command to trigger a system management interrupt for the basic input and output system, and load a fault diagnosis driver based on the firmware volume file.

17. (canceled)

18. (canceled)

19. An electronic device, comprising a processor, a communication interface, a storage device, and a communication bus, wherein the processor, the communication interface, and the storage device communicate with each other through the communication bus;
the storage device, configured to store a computer program; and
the processor, when executing the computer program stored on the storage device, configured to implement a fault diagnosis driver loading method being applied to a computing device mounted with a basic input and output system, the computing device being configured with a baseboard management controller, the baseboard management controller being configured with a shared area, the shared area being configured to be mapped to a system memory of the basic input and output system, the computing device having a corresponding client device;
the client device being configured to add a firmware volume file for the basic input and output system to the shared area, the method comprising:
executing a system control interrupt when the computing device is powered on and the firmware volume file is detected, and acquiring the firmware volume file from the shared area; and
executing a power management and configuration interface command to trigger a system management interrupt for the basic input and output system, and loading a fault diagnosis driver based on the firmware volume file.

20. (canceled)

21. The method according to claim 1, wherein an area of a memory not used by the baseboard management controller is allocated to be configured as the shared area.

22. The method according to claim 13, wherein the client device is configured to:
send the standard format driver file to the baseboard management controller based on a file transfer protocol and an out-of-band management tool.

23. The method according to claim 4, wherein the baseboard management controller connects to the central processing unit through the high-level signal pin.
